(19) United States
(12) Patent Application Publication
(10) Pub. No.: US 2009/0043847 A1
(43) Pub. Date: Feb. 12, 2009

(54) Group Communication in a Communication System

(76) Inventor: Antti Laurila, Helsinki (FI)

Correspondence Address: Erin M Nichols;Hollingsworth & Funk, 8009 34th Avenue South, Suite 125, Minneapolis, MN, 55425, US

(21) Appl. No.: 12/224,924

(22) PCT Filed: Mar. 7, 2007
(86) PCT No.: PCT/FI2007/050123

§ 371 Date: Sep. 8, 2008

(30) Foreign Application Priority Data
Mar. 10, 2006 (FI) 20065157

(51) Int. Cl. G06F 15/16

(52) U.S. Cl. 709/204

(57) ABSTRACT

In a communication system providing a group communication service, a group document server is configured to detect that a scheduled conference for a group is created or modified in a group information document, and to send to an appropriate application server a group advertisement message which is extended to include a new flag, which indicates whether this group is used for a scheduled conference or not. Upon receiving the message with the scheduled conference flag, the application server is adapted to fetch a respective group document from the group document server and with it also the information about the scheduled conference of the group. The application server then schedules the conference to initiate according to the received information.

### FIELD OF THE INVENTION

The present invention relates to group communication in communication systems providing a group communication service.

### BACKGROUND OF THE INVENTION

One special feature offered in mobile communication systems is group communication. The term “group”, as used herein, refers to any logical group of two or more users who participate in the same group communication. One example of group communication is a group call, which is a call in which all participants may take turns to speak and to listen to each other.

Conventionally, group communication has been available only in trunked mobile communication systems, such as Professional Mobile Radio or Private Mobile Radio (PMR) systems, for example TETRA (Terrestrial Trunked Radio), which are special radio systems primarily intended for professional and governmental users. Thanks to the evolvement of communication technology, particularly IP-based communication technology, and end user equipment, a group communication service is now also available in public mobile communication systems. Examples of services providing a group communication service include Push-to-talk over Cellular (PoC), messaging (IM), and conferencing, all implemented using primitives provided by SIP (Session Initiation Protocol) which is not vertically integrated into a communication system but a tool to build a multimedia architecture. Such group communication can include data calls, audio calls, video calls, multimedia calls, messaging, electronic mail, etc. SIP is an application-layer control (signaling) protocol for creating, modifying, and terminating sessions with one or more participants defined by Internet Engineering Task Force (IETF). IETF specifications and Internet Drafts can be found at http://www.ietf.org. PoC specification is currently being developed by a PoC work group under the Open Mobile Alliance (OMA). OMA specifications are available at http://www.openmobilealliance.org.

Push-to-Talk over Cellular (PoC) introduces a new real-time direct one-to-one and one-to-many voice communication service in a cellular network. The principle of communication behind the service is simple—just push to talk. Thanks to the ‘always-on’ connection, calls can be started to both individuals and talk groups with just a push of a key. Call connection is almost instantaneous and the receiver doesn't have to answer the call. Push-to-Talk service users are typically engaged in some other activity than a telephone call, and they listen to group traffic during their activity. A user can be contacted by name, or he may occasionally want to say something to the group. Half-duplex traffic is ideal for such use cases. This simple, real-time direct communication serves the diverse needs of users ranging from controlled team management to spontaneous sharing of experiences. Among the many benefits of this solution over conventional two-way radio systems are the attractive cellular phones and the simple and fast creation of talk groups and group calls. OMA PoC Service Enabler is a vendor-independent solution that is based on standard VoIP protocols such as SIP and RTP/RTCP. Clients typically use mobile data connections (e.g. GPRS or UMTS) and IP Multimedia Subsystem (IMS) specified by 3GPP to connect to a PoC Server.

OMA has defined a generic framework for group and list management called XDM (XML Document Management) based on XCAP protocol (XML Configuration Access Protocol). XDM defines a common mechanism that makes user-specific service-related information accessible to the different service enablers that need it. Examples of service enablers which may use XDM include PoC and Presence services. Such information is expected to be stored in the network where it can be located, accessed and manipulated (create, modify, retrieve, delete) by authorized principals. A client is able to identify elements inside one XML document and modify only the ones that need it. Documents accessed and manipulated via XCAP are stored in logical repositories in the network, called XML Document Management Servers (XDMS). Each repository may be associated with a functional entity, which uses its data to perform its functions. A client has one contact point for XCAP requests, the Aggregation Proxy which authenticates and routes the request to correct XDMS. For example, a PoC server accesses a PoC XDMS or Shared Group XDMS to obtain a particular type of user document, a PoC Group document, which provides the member list for a PoC group session, and the server uses this information to invite the members for a PoC session. Presence XDMS contains authorization policy documents, which are used to authorize watchers subscribing presence information and RLS presence list documents, which are used to subscribe with one request the presence of listed users.

In accordance with the Shared XDMSs XDM 2.0 architecture, the Shared XDMSs is a logical entity that may include three different functional repositories: Shared List XDMS, Shared Group XDMS and Shared Profile XDMS.

The Shared List XDM Specification is a specific type of repository, which stores documents as URI Lists. An URI list is a convenient way to group together a number of URLs (e.g., as “Friends”, “Family”, etc.) or other resources, where such a list is expected to be reused for a number of different services. Such a list is not enabler-specific and can be reused wherever a principal needs to collectively refer to a group of other end-users or resources. For example, a reference to a list of “Friends” can be an entry in a PoC Group member list or one included in a Presence list. For example, a PoC Server accesses a Shared Group XDMS or PoC XDMS to obtain a Shared Group document, which provides the information of the group (e.g. member list, conference type, supported medias, etc.). Shared List XDMS is the same repository in the OMA XDM 2.0 architecture as Shared XDMS was in the OMA XDM 1.0 architecture. The descriptive word “List” was just added there to separate it from the other two types of Shared XDMSs in the OMA XDM 2.0 architecture.

The Shared Group XDM is a specific type of repository, which stores documents called “the static group definition”. This is a convenient way for a principal to use the same group definition with multiple enablers (e.g. PoC and SIMPLE IM).

The Shared Profile XDM is a specific type of repository, which stores “user profile information” documents. This is a convenient way for a principal to use the same user profile information with multiple enablers (e.g. PoC and SIMPLE IM).

The Shared Group XDMS also has an optional mechanism to advertise certain groups to the members of a group. This is done by sending a Group Advertisement (GA) message, which is used to inform other users of the existence of a certain group. In other words user A can send GA to all of his friends to advertise a certain group he has just created for them to communicate with each other. GA includes at least Group URI of the group, the type of the Group and which media types are supported by this group. It can also include a display name of the group and free text describing this group.

In addition to the XCAP Document Management operations, users can subscribe to changes in the XML documents. Subscriber can be addressed using either the owner's SIP URI or the PSI URI of the group.

### BRIEF DESCRIPTION OF THE INVENTION

An object of the present invention is to provide a new mechanism for initiating a conference session in communication systems providing a group communication service.

The object of the invention is achieved by a method, servers and computer program products which are characterized by what is stated in the independent claims. Preferred embodiments of the invention are disclosed in the dependent claims.

An aspect of the present invention is an improvement in a group document server, such as a shared group XDMS in the OMA XDM 2.0 architecture, which contains generic group and list management data. A group document may provide not only normal group information, but also information about a scheduled conference of the group. For example, a user can define the start time of the scheduled conference. However, a group document server, such as the shared group XDMS, is a data repository, whereas application services, such as PoC, are controlled by application servers, such as the PoC servers. Therefore, a group document server according to the aspect of the invention is configured to detect that a scheduled conference for a group is created or modified in a group information document, i.e. at least a start time, optionally also an end time and/or other criteria of the scheduled conference is created or modified. The optional other criteria may include the presence information of at least one group member. Upon detecting a creation or modification of a scheduled conference, the group document server creates a message, such as a Group Advertisement message GA, which is extended to include a new flag, which indicates whether this group is used for the scheduled conference or not.

Another aspect of the present invention is an improvement in an application server. Upon receiving a predefined message, e.g. group advertisement message with the scheduled group flag set as TRUE, the application server is adapted to fetch a respective group document from the group document server and with it also the created or modified information about the scheduled conference of the group, such as the start/stop time of the conference. Based on the retrieved information, the application server is adapted to initiate a conference when the scheduled time comes.

The present invention provides an easy-to-implement solution for providing a scheduled conference for a group. An advantage is that an appropriate application server can, on the user's behalf, automatically detect and initiate a scheduled conference, which is defined in a group document server.

### BRIEF DESCRIPTION OF THE DRAWINGS

In the following, the invention will be described in greater detail by means of preferred embodiments and with reference to the accompanying drawings, in which

FIG. 1 illustrates an example of a general architecture of a communication system providing a group communication service;

FIG. 2 is a signaling diagram illustrating signaling according to an embodiment of the invention,

FIG. 3 is a flow diagram illustrating an example of the operation of a group document server according to an embodiment of the invention, and

FIG. 4 is a flow diagram illustrating an example of the operation of an application server according to an embodiment of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such a reference is made to the same embodiment(s), or that the feature only applies to a single embodiment. In addition, the embodiments presented below or parts thereof can be combined to produce preferred embodiments of the invention.

The present invention is applicable to any user equipment, servers and/or to any communication system or any combination of different communication systems that support group communication. No limitations exist to the message format, nor to the group type. The communication system may be a fixed communication system or a wireless communication system or a communication system utilizing both fixed networks and wireless networks. The protocols used, the specifications of communication systems and user equipment, especially in wireless communication, develop rapidly. Such development may require extra changes to the invention. Therefore, all words and expressions should be interpreted broadly, and they are intended to illustrate, not to restrict, the invention.

In the following, the present invention will be described using, as an example of a system architecture to which the present invention may be applied, an architecture based on SIP, providing a tool to build a multimedia architecture and utilizing XDM (XML Document Management) without restricting the invention to such an architecture, however.

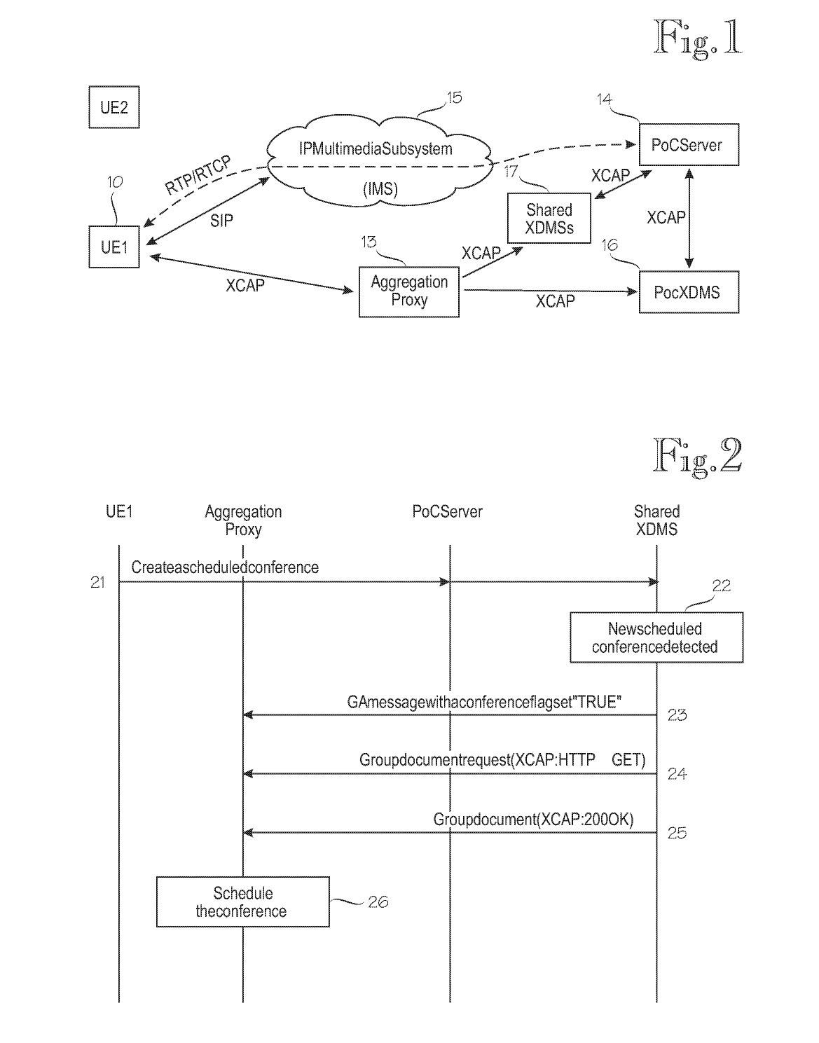

An example of an architecture of a communication system providing a group communication service utilizing SIP and XCAP is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements, and protocols used in or for group communication or for advertising a group, are irrelevant to the actual invention. Therefore, they need not be discussed in more detail here.

The communication system comprises user equipment (UE) 10, such as a mobile station, which is capable of communicating via an access communication system 15 (such as an IP Multimedia Subsystem (IMS)) with an application server (e.g. PoC server) 14, and with an aggregation proxy 13 which provides access to an application XML Document Management Server (XDMS) 16 and a shared XDMSs 17. As functional entities, UE 10, and the PoC server 14 may contain an application client with which the service provided by the application is accessed, and an XML Document Management Client (XDMC) with which XML documents, or an element/elements within an XML document, may be created, deleted, modified and retrieved, for example. Typically, control plane traffic, such as SIP signaling, passes through IMS 15 but user plane traffic passes between UE 10 and the application server 14. Group and list management traffic using the XCAP protocol goes between UE 10 (or, more precisely, XDMC in the UE) and the application XDMS 16 or the shared XDMSs 17 via the aggregation proxy 13.

The aggregation proxy 13, application XDMS 16 and shared XDMSs 17 are XDM functional entities. XDM defines a common mechanism that makes user-specific service-related information, such as group definitions, accessible to different applications (service enablers) and clients residing in user equipment, and enables creation, modification, retrieval and deletion of such information. The information, more precisely, XML documents, is stored in XDMSs. The application XDMS 16 is an application-specific server, such as the PoC XDMS, i.e. it serves one or more application servers, each for the same particular application, whereas the shared XDMSs 17 serves application servers for different applications in the system and contains generic group and list management data. The aggregation proxy 13 routes an individual XCAP request from the XDMC to the correct XDMS. Thus, users of an XDM server may include mobile terminals (e.g. PoC Client), and other servers (e.g. PoC Server).

The application providing the group communication service may be PoC, messaging, or conferencing, for example. PoC specification is currently being developed by a PoC work group under the OMA. More detailed information on the PoC can be found via the above-mentioned Internet pages of OMA. SIMPLE, defined by IETF, provides an instant messaging (IM) service. OMA also defines an IM (Instant Messaging) enabler based on SIP/SIMPLE protocols. Thus, the application server 14 may be a PoC server, an instant messaging server, or a conference server that supports different media types, such as audio, video and messaging. Since the application XDMS 16 serves a single application, the application XDMS 16 may be a PoC XDMS or instant messaging XDMS. For example, when the application is PoC, contact lists may be stored in the shared XDMSs 17 and/or in the PoC XDMS, i.e. application XDMS 16, which contains PoC group documents. (In XDM 2.0 Architecture a PoC Group document can be stored in Shared XDMSs as well). A PoC group document providing a member list for a PoC group session is thus accessible to UE 10 and to a PoC server, i.e. the application server 14, and they can utilize the member list when advertising the group or when establishing a group session (inviting group members to a group session). The PoC group document according to the invention preferably also contains other attribute(s) for the group in addition to the member list.

In an embodiment where the Shared XDMSs XDM 2.0 architecture is applied, the Shared XDMSs 17 may be a logical entity that may include three different functional repositories: Shared List XDMS, Shared Group XDMS and Shared Profile XDMS. The functionality according to the invention may then preferably be implemented in the Shared Group XDMS in the OMA XDM 2.0 architecture, for example. However, it should be appreciated that the specific operation and architecture of the Shared XDMSs 17 is not relevant to the present invention.

Example embodiments of the invention will be described below with reference to FIGS. 2, 3 and 4.

An aspect of the present invention is an improvement in a group document server, such as a shared XDMSs 17, which contains generic group and list management data. A group document may provide not only the group information above, but also information about the schedule of the group. For example, a user can define the start time and end time of the scheduled conference (transaction 21 in FIG. 2). However, the group document server, such as the shared group XDMS, is a data repository, whereas the application services, such as PoC, are controlled by the application servers, such as the PoC servers. Therefore, a group document server according to the first aspect of the invention is configured to detect that a scheduled conference for a group is created or modified in a group information document, i.e. at least a start time, optionally also an end time and/or other criteria of the scheduled conference are created or modified (block 22 in FIG. 2, and step 31 in FIG. 3). The other criteria may include the presence information of at least one group member. Upon detecting a creation or modification of a scheduled conference, the group document server creates a Group Advertisement message GA which is extended to include a flag, which indicates whether this group is used for a scheduled conference or not (step 32 in FIG. 3). The Group Advertisement message is then sent to an Application Server which may be selected based on a supported media types field in the Group information (transaction 23 in FIG. 2, steps 33 and 34 in FIG. 3). For example, in a case where the supported media type is a PoC call, the group advertisement message GA will be sent to the PoC server(s). In a case where the decision from step 31 is no, any possible group advertisement sent to this group before next checking step 31 may include a scheduled conference flag which is set to “FALSE” (step 35 ).

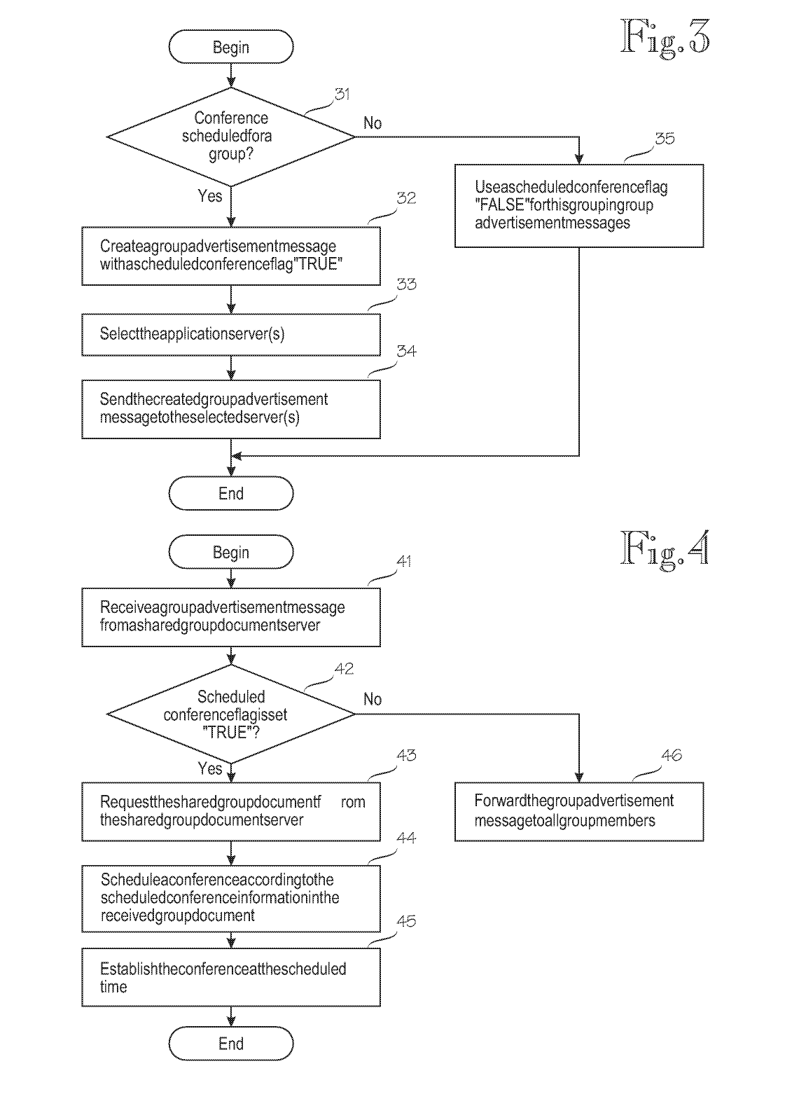

When the application server receives a group advertisement message GA (step 41 in FIG. 4) and notices that the scheduled group flag is set to “TRUE” (step 42 in FIG. 4), the application server will fetch the respective group document from the group document server (step 43 in FIG. 4) and with it also the created or modified information about the scheduled conference of the group, such as the start/stop time of the conference. This can be implemented by a standard XCAP method which may include sending a group document request in the form of an HTTP GET message (message 24 in FIG. 2) and receiving the group document in a 200 OK message (message 25 in FIG. 2). Based on the retrieved information, the application server can then schedule the conference (block 26 in FIG. 2, step 44 in FIG. 4) and initiate the conference when the scheduled time comes (step 45 in FIG. 4). The application server may not send the group advertisement message with the scheduled group flag set to “TRUE” to members of the group because this message is primarily intended for informing the application server about the scheduled conference, which information is not necessarily needed by the group members, or is provided them by some other means. Upon receiving a group advertisement message containing no scheduled group flag or containing a scheduled group flag set to “FALSE” (decision No from step 42 in FIG. 4), the application server will operate as before and fork the group advertisement message to all members of that group (step 46 in FIG. 4). The scheduled conference flag as used herein refers to any field or parameter assigned for this purpose in a message. The flag values “TRUE” and “FALSE” can be implemented by any appropriate numerical values or other codes.

The present invention allows that an appropriate application server can, on the user's behalf, automatically initiate a scheduled conference, which is defined in a group document server.

A short example of a scheduled group based on the OMA Shared Group XDM Specification:

Content-Type: application/list -service+xml
<?xml version=″1.0″ encoding=″UTF -8″?>
<group xmlns=″urn:oma:params:xml:ns:list -service″
xmlns:rl=″urn:ietf:params:xml:ns:resource -lists″
xmlns:ext=″urn:oma:params:xml:ns:shared -group″
xmlns:cr=″urn:ietf:params:xml:ns:common -policy>

<list-service uri=″sip:conference@example.com″>
<display-name xml:lang=″en -us″>Concertdiscussion</display
-name>
<list>

<entry uri=″tel:+4 3012345678″/>
<entry uri=″sip:name.surname@example.com″>

<display-name>UserA</display-name>

</entry>

</list>
<ext:schedule>

<ext:activation-time>2005-12-12T9:00</ext:activation -time>
<ext:end-time cond=“exact”>2005-12-12T20:00 </ext:end-time>

</ext:schedule>
</list-service>

</group>

An example of an extended group advertisement message GA:

MESSAGE: sip:summervacation@poc.home1.fr SIP/2.0
From: <sip:tobias@home1.fr>; tag=31415
TO: <sip:summervacation@poc.home1.fr>
Accept-Contact: *;+g.poc.groupad; require;explicit
User-Agent: PoC-client/OMA1.0
Content-Type: application/vnd.poc.group -advertisement+xml
Content-Lenght: (482)
<?xml version=“1.0” encoding=“UTF -8”?>
<group-advertisement

xmlns=“urn:oma:params:xml:ns:poc:group -advertisement”
xmlns:xsi=“http://www.w3.org/2001/XMLSchema -instance”
xsi:schemaLocation=“urn:oma:params:xml:ns:poc:groupadvertisement”>
<note>Tobias summer vacation planning</note>
<group type=“dialed-in”>

<display-name>Great trip to Finland</display -name>
<uri>sip:summervacation@poc.example.com</uri>
<communication -means=“poc”;“messaging”;“video”>
<server -to-server-information>

<scheduled-group=“TRUE”>

</server-to-server-information>

</group>

</group-advertisement>

However, it should be appreciated that the message used for notifying of a scheduled conference may be any suitable signaling message, an existing one or a new one. The use of a Group Advertisement message GA which is extended with a scheduled conference flag is, however, advantageous because a need for a new signaling message for this purpose is avoided. An example of an application server is illustrated in U.S. patent application Ser. No. 10/880,982 of the same applicant, which U.S. patent application is incorporated herein by reference. (The corresponding PCT application is PCT/FI2005/050137).

The servers or corresponding server components and/or other corresponding devices implementing the functionality of the present invention comprise not only prior art means but also means for forming, sending and/or receiving messages advertising the group and containing a scheduled group conference flag, means for retrieving a group document, and means for initiating a scheduled conference in the group in the manner described above. Present servers comprise processors and memory that can be utilized in the functions according to the invention. All modifications and configurations required for implementing the invention may be performed as routines, which may be implemented as added or updated software routines, application specific integrated circuits (ASIC) and/or programmable circuits. Software routines, also called program products, including applets and macros, can be stored in any device-readable data storage media and they include program instructions to perform particular tasks. Software routines may be downloaded into a device.

It will be obvious to a person skilled in the art that, as technology advances, the inventive concept can be implemented in various ways. The invention and its embodiments are not limited to the examples described above but may vary within the spirit and scope of the claims.

1. A method, wherein:
a group document server detects that a scheduled conference for a group is created or modified in a group document,
in response to detecting a creation or modification of a scheduled conference, the group document server sends to an appropriate application server a message which indicates that this group is used for a scheduled conference,
in response to receiving said message, the application server retrieves said group document from the group document server and with said group document also schedule information about the created or modified scheduled conference of the group,
the application server schedules the conference to initiate according to said schedule information in a communication system providing a group communication service.

2. A method according to claim 1, wherein said message is a Group Advertisement message which is extended to include a flag, which indicates whether this group is used for a scheduled conference or not.

3. A method according to claim 1, wherein said retrieving comprises
the application server sends a group document request to the group document server, preferably a HTTP GET message, and
the group document server sends the group document to the application server, preferably in a 200 OK message.

4. A method according to claim 1, wherein the group document is an XML document, and the group document server is a group XML document management server.

5. A method according to claim 1, wherein said schedule information includes at least a start time, optionally also an end time and/or other criteria of the scheduled conference, such as presence information of at least one group member.

6. A group document server, wherein
the group document server for a communication system providing a group communication service is accessible to a user for creating or modifying a scheduled conference for a group in a group document,
the group document server is configured to detect that a scheduled conference for a group is created or modified in a group document,
the group document server is responsive to detecting the creation or modification of a scheduled conference for sending to an appropriate application server a message which indicates that this group is used for a scheduled conference.

7. A server according to claim 6, wherein said message is a Group Advertisement message which is extended to include a flag, which indicates whether this group is used for scheduled conference or not.

8. A server according to claim 6, wherein
the group document server is configured to select the appropriate application server based on supported media types field in the group document.

9. A server according to claim 6, wherein
the group document server is configured to receive from the application server a group document request, preferably a HTTP GET message, and
the group document server is configured to send the group document to the application server, preferably in a 200 OK message.

10. A server according to claim 6, wherein the group document is an XML document, and the group document server is a group XML document management server.

11. An application server, wherein
the application server is configured to receive from a group document server a message which indicates that there is a scheduled conference for a communication group in a communication system providing a group communication service,
in response to receiving said message, the application server retrieves a group document of the respective communication group from the group document server and with said group document also schedule information about the scheduled conference of the group,
the application server is configured to schedule the conference to initiate according to said schedule information.

12. A server according to claim 11, wherein said message is a Group Advertisement message which is extended to include a flag, which indicates whether this group is used for scheduled conference or not.

13. A server according to claim 11, wherein
in response to receiving said message, the application server sends a group document request to the group document server, preferably a HTTP GET message, and
the application server is configured to receive the group document from the group document server, preferably in a 200 OK message.

14. A server according to claim 11, wherein the application server is a PoC server, and the group document is an XML document.

15. A computer program embodied in a computer-readable medium and comprising program instructions, wherein the execution of said program instructions causes a device containing the computer program product to implement at least the following operations of a group document server:
detecting that a scheduled conference for a group is created or modified in a group document,
in response to detecting a creation or modification of a scheduled conference, sending to an appropriate application server a message which indicates that this group is used for a scheduled conference.

16. A computer program embodied in a computer-readable medium and comprising program instructions, wherein the execution of said program instructions causes a device containing the computer program product to implement at least the following operations of an application server:
receiving from a group document server a message which indicates that there is a scheduled conference for a communication group,
in response to receiving said message, retrieving a group document of the respective communication group from the group document server and with it also schedule information about the scheduled conference of the group,
scheduling the conference to initiate according to said schedule information.
